(19) United States
(12) Patent Application Publication
(10) Pub. No.: US 2005/0001149 A1
(43) Pub. Date: Jan. 6, 2005

(54) Stray light correction method for an optical sensor array

(75) Inventor: Michael Beuschel, Koesching (DE)

Correspondence Address: FASSE PATENT ATTORNEYS, P.A., P.O. BOX 726, HAMPDEN, ME, 04444-0726, US

(73) Assignee: Conti Temic Microelectronic GmbH, Nuernberg (DE)

(21) Appl. No.: 10/497,039

(22) PCT Filed: Nov. 8, 2002
(86) PCT No.: PCT/DE02/04128

(30) Foreign Application Priority Data
Dec. 6, 2001 (DE) 101 59 932.3

(51) Int. Cl. H01J 40/14

(52) U.S. Cl. 250/214 B

(57) ABSTRACT

In optical sensor arrangements, in addition to the desired useful signal, which is caused by light reflection of potential collision objects, additional components also arise which can superimpose on and thus falsify the useful signal. The signal curve or course of the interfering or stray light component is moreover dependent on further effects. Method for the interfering or stray light correction in an optical sensor arrangement, which consists of a light emitter and an associated receiver, whereby light signals are emitted by means of the light emitter in periodic time intervals into the field of view of the sensor arrangement for the detection of objects, and reflected components of the light signals incident on the receiver indicate the presence of objects, characterized in that a sampled value is generated from the reflected components of the light signals incident on the receiver, and a correction value for the sampled value is determined in a state in which no object to be recognized is present in the field of view of the sensor arrangement. The invention is suitable as an evaluating method for optical precrash sensors.

The invention relates to a method for the interfering or stray light correction in an optical sensor arrangement according to the preamble of the patent claim 1. The inventive method is especially suitable as an evaluating method for optical precrash sensors in vehicles, so-called CV sensors (closing velocity, approaching speed).

In order to improve the safety in road traffic, optical sensor arrangements are increasingly installed as obstacle warning systems in vehicles, which, for supporting or assisting the occupant protection system as well as the driver, predominantly detect the immediate surrounding environment in front of the moving vehicle and warn of danger sources, such as, for example, stationary or moving obstacles on the roadway.

In optical sensor arrangements, in addition to the desired useful signal, which is caused by light reflection of potential collision objects, further components also arise, which may superimpose on and thus falsify the useful signal, for example reflections within the sensor housing, reflections on the windshield as a result of the law of refraction, additional reflections on the windshield as a result of soiling, or reflections on vehicle body parts (for example engine hood).

The signal characteristic or curve of the stray light component is moreover dependent on further effects, such as the temperature of the involved or participating components (for example the pulse form of the emitter and transmission behavior of the receiver).

Previously, there exist the following starting points for the solution of the problem:

The suppression of stray light can result on the optical side in that an additional optical sensor is arranged so that it receives only stray light but no useful signal during the object measurement (differential sensor). This approach seems problematic, for constructive reasons as well as due to the increased hardware effort or expenditure, because an arrangement suitable for all operating situations practically cannot be discovered.

If no comparative measurement can take place, there exists the possibility of the negative coupling of an electrical signal into the receiver. This approach is similarly problematic due to the increased hardware effort or expenditure. Moreover, a coupling-in behavior suitable for all operating situations must be determined.

For the suppression of stray light, a constant characteristic field with correction values for each sampled time point can also be utilized after the sampling and digitizing of the measured values. These values are respectively subtracted from the associated sampled value before the further processing of the data. Since the effect of the stray light is dependent on the temperature-dependent pulse form of the emitter, among other things, this additional dependence must similarly be considered and calibrated. Effects such as the dirtying or soiling of the windshield are not detectable and cannot be corrected with this approach.

A shifting of the temporal reception window may also serve for the suppression of stray light through very close reflections (electrical or logical shifting or screening). This is possible if the smallest object distance to be detected is larger than the pulse duration recalculated or converted to the distance. In the application case being considered, a minimum object distance of approximately 2 m is opposed or compared to a pulse length of approximately 5 m. Therewith it would give rise to an unacceptable screening of relevant information.

A solution to the problem, known for example from the German Laying-Open Document DE 41 41 469 A1, exists in carrying out a corresponding comparative measurement without object for each measurement with object. Through difference formation of both measurements, then the stray light influence can be substantially eliminated.

In detail, a possibly present interfering or stray signal is detected before and/or after emitting of a light signal, and the information acquired thereby is utilized for the determination of the stray signal characteristic or curve during the light signal emission. Thereupon, the previously determined stray signal is subtracted from the received total light signal, in order to obtain the desired useful signal in this manner.

In this regard it is disadvantageous on the one hand, that reference measurements are necessary before/after emission of the light signal, in order to determine the stray signal therefrom. These reference measurements reduce the operating capacity or efficiency of the sensor. On the other hand, exclusively external influences are detected as stray signals, whereby only these can be corrected. Optical reflections of signal components of the emitter itself, which cannot be further reduced as necessitated by the installation, as well as electrical cross-talk of the emitter activation onto the receiver, are thus not recognized as stray signals. Moreover, the temporal behavior of the components of the total light signal is not considered, whereby, for example, periodic and synchronous signal components are similarly not recognized as stray signals.

It is the underlying object of the invention to embody a method for the stray light correction according to the preamble of the claim 1 so that the operating capacity or efficiency of the sensor is considerably improved.

This object is achieved by a method with the characterizing features set forth in the claim 1.

The method according to claim 1 comprises the advantages, that no reference measurements are needed, and all measurements take place in normal emitting operation. In addition to slow external stray components, those which stand in a causal connection with the light emitter, such as optical reflections or cross-talking, can also be considered and corrected. Furthermore, periodic and synchronous signal components are recognized as interferences. Moreover, a reduction of the necessary hardware resources and of the calibrating effort or expenditure in the fabrication are achieved.

In order to be able to evaluate useful signals of very small amplitude, existing stray signals are corrected by undesired optical effects, so-called stray light or interfering light. This increases the sensitivity of the sensor.

The proposed autonomously operating and adaptive algorithm saves or obviates a calibration of the sensor during the fabrication and similarly adapts itself automatically to environmentally necessitated drift effects.

Advantageous embodiments of the method according to claim 1 are set forth in the dependent claims.

The invention will now be described in detail in connection with an example embodiment with the aid of the drawing.

It is shown by

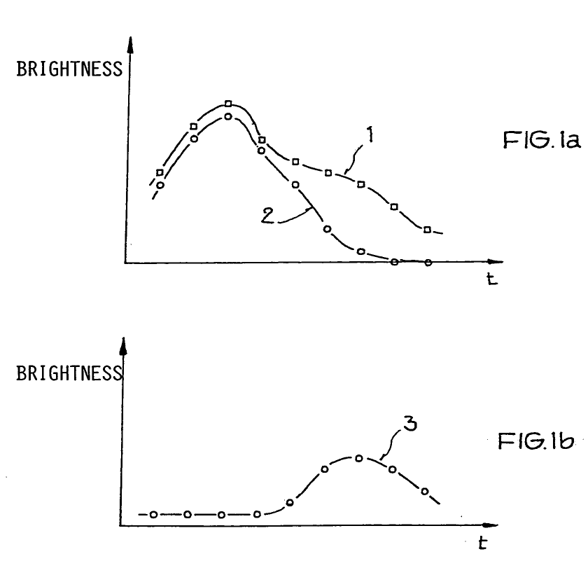

FIG. 1a: a diagram with the time sequence of the brightness or intensity of uncorrected sampled values and correction values of a fictitious comparative measurement;

FIG. 1b: a diagram with the time sequence of the brightness or intensity of corrected sampled values according to FIG. 1a; and

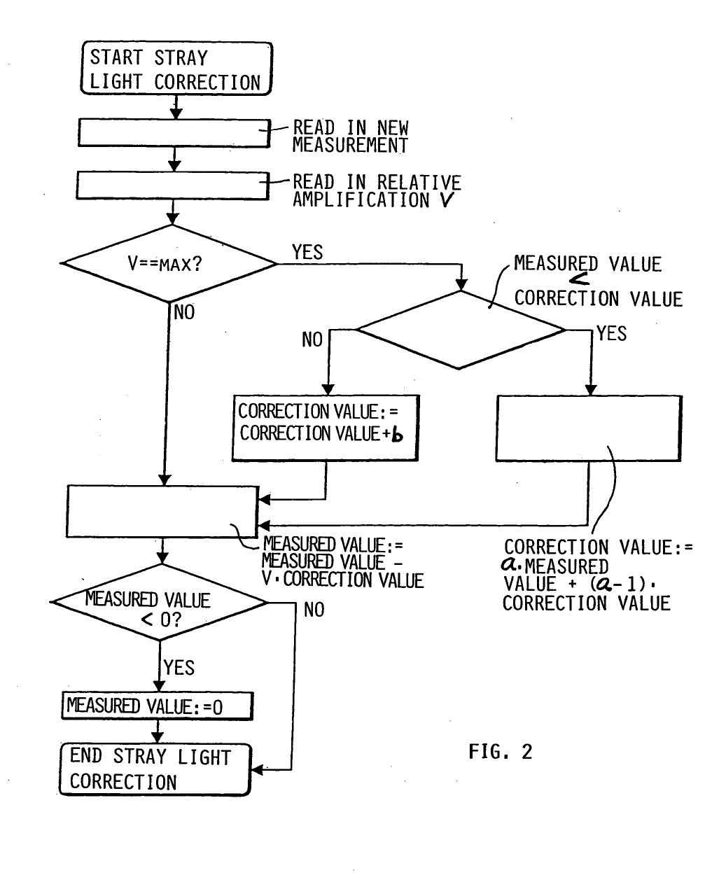

FIG. 2: a flow diagram with the algorithm according to the invention for the stray light correction.

For the resolution of the initially presented difficulties, the approach of a correction by means of data processing seems to be the most flexible and realizable with the smallest hardware effort or expenditure. The proposed solution is based on the principle of the comparative measurement. However, comparative measurements, as required initially, are not practicable in the field. As a remedy, for each sampled value there is suggested an adaptive correction value that is oriented with respect to a fictitious comparative measurement:

Since the sensor arrangement provided for the intended application is designed for speeds not equal to zero, for objects of limited extent, the state or condition always arises within certain time spacings or intervals, that no object to be recognized is present in the field of view of the sensor arrangement (or respectively within a determined distance window). This state is utilized as comparative measurement.

The algorithm suggested for this purpose recognizes such states and uses them for the calibration of the correction values. The correction values are thereafter subtracted from the associated measured values.

The FIG. 1a shows a diagram with the time sequence of the brightness or intensity of uncorrected sampled values and correction values from a fictitious comparative measurement. A first curve 1 contains the uncorrected measured values, from which an object to be measured is not recognized, because maximum and center of concentration of the signal are dominated by the stray light components. If, in comparison thereto, correction values, which are contained in a curve 2, are determined from preceding measurements, these can be subtracted from the measured values. The signal remaining in a curve 3 of the FIG. 1b clearly illustrates the component of the object to be measured.

It is taken advantage of in the proposed method, that the stray light sources vary very slowly in comparison to the useful signal (for example due to temperature drift). Because all signal components are positively superimposed, thereby the measured signal can never fall or sink below the values necessitated by the stray light component.

A flow diagram with the algorithm according to the invention is evident from FIG. 2. For each sampled value, the algorithm uses a filter with direction-dependent behavior:
If an actual current measured value is less than a stored correction value (or equal), then the correction value is very rapidly reduced, however not to values below the actual current measured value. This case arises when an object has left the field of view of the sensor arrangement and thus the condition for a fictitious comparative measurement exist.
The reduction of the correction value may, for example, result from direct taking over of the (smaller) actual current measured value as the new correction value. If noise-induced minima are to remain out of consideration, then the adaptation can also take place according to the following formula (a represents an actualizing or updating degree, i is the index of the measured value):
   correction value_{new}(i)=a·measured value (i)+(1−a)·correction value_{old}(i)
This equation represents a weighted sum of the old correction value and the new measured value, whereby the sum of the weighting factors is always equal to one. For a=1, the actual current measured value is directly taken over as the new correction value. Thus, the adaptation essentially operates as a sliding or moving minimum of the measured values of a sampling process.
For 0<a<1, the behavior corresponds to a low pass of first order for the filtering of interferences, especially of downward outliers. Thereby, while the adaptation in a direction toward smaller correction values takes place more slowly than for directly taking over the measured value, instead the noise level is reduced, if, as the case may be, negative sampled values arising after the correction are set to zero.

If the actual current measured value is greater than the stored correction value, then the correction value is slowly increased, however not to values above the actual current measured value. This case covers slow variations of the stray light behavior (for example due to drift effects), to the extent they lead to an increase of the stray light component in connection with certain measured values (a reduction of the stray light component is covered by the adaptation mentioned in the preceding section).
The case that measured values are greater than the correction values also arises while an object is present in the field of view of the sensor. The increase of the correction values in that context must be so slow that the measurement of the object is not impaired. This is achieved, for example, in that the correction value is incremented by a value b>0 each time this case arises. The incrementing value b is not changed during the operation and advantageously is implemented as a parameter and is stored in a memory (EEPROM).

Alternatively, one of the two methods for increasing or reducing the correction values can always be utilized, with different adaptation rates in an upward or downward sense. In that regard, advantageously direction-dependent values a or b are selected, so that the adaptation to smaller correction values takes place more rapidly than to large ones.

An advantageous embodiment exists in that the change of the correction values in at least one direction takes place only upon fulfilling a condition. It is moreover of advantage, that a correlated signal is produced in connection with the presence of an object. The condition for the change of the correction values is, for example, fulfilled when the correlated signal exceeds or falls below a threshold value. It is furthermore of advantage, to determine a signal amplitude as a function of the sampled values and to define the signal amplitude as the maximum of the sampled values. Thereby, it is possible to represent the correlated signal by the signal amplitude.

In the implementation, additionally an existing scaling factor V for the emitted and received signal must be taken into consideration. The fictitious comparative measurement is scaled thereby. The scaling factor V is advantageously determined by a regulation or closed-loop control, and is maximal in connection with a missing object in the field of view of the sensor arrangement. In connection with a smaller scaling factor, one must begin from the presumption of the presence of an object in the field of view of the sensor arrangement. The scaling factor V can also advantageously be represented by the correlated signal.

The consideration of the scaling factor V in the determination of a new adaptive correction value can take place in the following manner:
The adaptation of the stray light correction, that is to say the determination of a new adaptive correction value, is activated only for maximum scaling factor V, thus when no object is to be recognized in the field of view of the sensor arrangement. This is suitable when a fixed upper limit of the correction values in the admissible or permitted operation is not exceeded and the correction values are not utilized for further running calculations.
The utilization of the stray light correction (however without adaptation) can in this case either also be limited to the operation with maximum scaling factor or alternatively be continued with the V scaled correction values for smaller scaling factors.
The adaptation and utilization of the stray light correction is activated for a fixed range of the scaling factor V (this also encompasses an activation in the entire scaling range). For the comparison with the actual current measured values, in this case the stored correction values must respectively be multiplied with the scaling factor V.

An existing amplification-independent offset of the signal must be taken into consideration in both cases.

The FIG. 2 shows the flow diagram for a sampled value and for the above described case without counters and adaptation only for maximum amplification. In that context, the process must be repeated for all sampled values.

Due to the dynamic adaptation of the correction, the proposed adaptive stray light correction is not suitable for stationary measurements (for which the utilized sensor arrangement is also not provided). The adaptation in the positive direction must respectively be designed so that the recognition of the weakest useful signal within the maximal measuring time

$${t}_{max} = \frac{Detection {Range}_{max}}{Object {Speed}_{min}}$$

is not significantly or appreciably impaired, that is to say, the entire adaptation in the positive direction during the maximum measuring time tₘₐₓ must be clearly smaller than the amplitude of the useful signal.

The correction method according to the invention is also in the position to compensate other quasi-stationary effects, such as, for example
electrical cross-talk, insofar as this is synchronous with the time window of the measurement (frequently the case in clocking or timing and trigger signals),
asymmetry of the digitization in the utilization of plural A/D converters operating in a time-offset manner,
offset of the entire measurement (only within one amplifier stage) and
slow dirtying or soiling of the viewing area (for example the windshield).

Additionally, the stored correction values can be used, under certain pre-conditions, for the diagnosis of the sensor and for the calibration of the distance calculation, because they always reflect the actual current state of the sensor and the sensor environment.

1. Method for the stray light correction in an optical sensor arrangement, which consists of a light emitter and an associated receiver, whereby light signals are emitted by means of the light emitter in periodic time intervals into the field of view of the sensor arrangement for the detection of objects, and reflected components of the light signals incident on the receiver indicate the presence of objects, characterized in that a sampled value is generated from the reflected components of the light signals incident on the receiver, and a correction value for the sampled value is determined in a state in which no object to be recognized is present in the field of view of the sensor arrangement.

2. Method according to claim 1, characterized in that the correction value is stored.

3-19. (canceled).

20. Method according to claim 2, characterized in that the stored correction values are subtracted from the sampled values.

21. Method according to claim 2, characterized in that, for a measured value of a subsequent measurement, the correction value is reduced if the actual current measured value is less than the stored correction value.

22. Method according to claim 2, characterized in that, for a measured value of a subsequent measurement, the correction value is increased if the actual current measured value is greater than the stored correction value.

23. Method according to claim 2, characterized in that, for a measured value of a subsequent measurement, the correction value is reduced if the actual current measured value is less than the stored correction value, and/or the correction value is increased if the actual current measured value is greater than the stored correction value.

24. Method according to claim 23, characterized in that the change of the correction value in at least one direction takes place by addition or subtraction of a value (b).

25. Method according to claim 24, characterized in that the value (b) to be added or to be subtracted is greater than zero.

26. Method according to claim 23, characterized in that the change of the correction value in at least one direction takes place according to the equation
correction value_{new}(i)=a·measured value (i)+(1−a)·correction value_{old}(i)
with an actualizing or updating degree (a).

27. Method according to claim 23, characterized in that the change of the correction values to smaller and larger values takes place with different methods.

28. Method according to claim 23, characterized in that the change of the correction values to smaller values takes place more quickly than to larger values.

29. Method according to claim 23, characterized in that the change of the correction values in at least one direction only takes place when an associated condition is fulfilled.

30. Method according to claim 1, characterized in that a scaling factor (V) for the emitted or received signal is taken into consideration in the calculation.

31. Method according to claim 30, characterized in that the scaling factor (V) is determined through a regulation or closed-loop control.

32. Method according to claim 1, characterized in that a correlated signal is produced in connection with the presence of an object.

33. Method according claim 1, characterized in that a signal amplitude is determined as a function of the sampled values.

34. Method according to claim 33, characterized in that the signal amplitude is defined as the maximum of the sampled values.

35. Method according to claim 33, characterized in that a correlated signal is produced in connection with the presence of an object, and the correlated signal is represented by the signal amplitude.

36. Method according to claim 32, characterized in that the change of the correction values in at least one direction only takes place when an associated condition is fulfilled, and the condition is fulfilled when the correlated signal exceeds or falls below a threshold value.

37. Method according to claim 30, characterized in that a correlated signal is produced in connection with the presence of an object, and the correlated signal represents the scaling factor (V) for the emitted or measured signal.
